(19) United States
(12) Patent Application Publication
(10) Pub. No.: US 2018/0340557 A1
(43) Pub. Date: Nov. 29, 2018

(54) HOSE CLAMP WITH INDICATOR

(71) Applicant: IDEAL CLAMP PRODUCTS, INC., Smyrna, TN (US)

(72) Inventor: Bruce D. BOWATER, Franklin, TN (US)

(21) Appl. No.: 15/990,028

(22) Filed: May 25, 2018

Related U.S. Application Data
(60) Provisional application No. 62/511,543, filed on May 26, 2017.

(51) Int. Cl. F16B 1/00; F16B 2/08; F16L 33/025

(52) U.S. Cl. CPC F16B 1/0071; F16L 33/025; F16B 2/08

(57) ABSTRACT

A hose clamp is disclosed. The hose clamp includes an indicator that indicates a predetermined band tension.

This application claims priority to U.S. Provisional App. No. 62/511,543, which was filed on May 26, 2017 and is expressly incorporated herein by reference.

### BACKGROUND

The present disclosure relates to clamp designs and, more specifically, to a design for a hose clamp.

### TECHNICAL FIELD

Hose clamps are commonly utilized to join together hoses and fittings or connectors, for example, within the automotive industry. Hose clamps may include a liner that may be spot welded, riveted, or otherwise fastened to a circular outer band and a locking mechanism to couple the ends of the outer band together and apply tension to the clamp. A radial load may be created by the tension and may be transmitted to the fittings of the joint as a radial load. Examples of hose clamps are shown and described in U.S. Pat. Nos. 8,650,719; 8,677,571; and 7,302,741, which are incorporated herein by reference.

Hose clamps may be sold to companies that supply hose or duct sub-assemblies to the end user. These sub-assemblies typically include a hose substrate and one or more clamps. A typical hose clamp application targets a predetermined band tension that is determined empirically or theoretically to affect a seal on a hose/fitting assembly (joint). Band tension is a function of installation torque, bolt diameter, thread “K” factor, spring rate of the hose/joint, and friction between the clamp and the hose.

In many clamp designs, spring rate, friction, “K” factor, and bolt diameter are assumed to be constant such that the band tension is then directly proportional to installation torque. This assumed proportionality of band tension and installation torque has led many clamp users to target a pre-determined installation torque to generate the targeted band tension to affect the proper seal. This assumed proportionality is difficult to replicate during manufacturing, when typical manufacturing tolerances make it difficult to maintain the spring rate, friction, “K” factor, and bolt diameter constant.

### SUMMARY

According to one aspect of the disclosure, a hose clamp is disclosed. The clamp uses a spring system in series with the screw and band to alert the installer when a proper band tension has been achieved. The spring system is comprised of a spring or springs that have a visual indicator positioned at a predetermined position. When a predetermined band tension is achieved, the springs compress, and a shield or bracket covers the visual indicator.

### BRIEF DESCRIPTION OF THE DRAWINGS

The detailed description particularly refers to the following figures, in which:

FIG. 1 is a perspective view of a hose clamp with a visual indicator;

FIG. 2 is a cross-sectional perspective view of the hose clamp of FIG. 1 taken along the line 2-2 in FIG. 1;

FIG. 3 is a perspective view similar to FIG. 1 showing the hose clamp after tightening; and

FIG. 4 is a cross-sectional perspective view of the hose clamp of FIG. 3 taken along same line as FIG. 2 showing the hose clamp after tightening.

### DETAILED DESCRIPTION OF THE DRAWINGS

While the concepts of the present disclosure are susceptible to various modifications and alternative forms, specific exemplary embodiments thereof have been illustrated by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

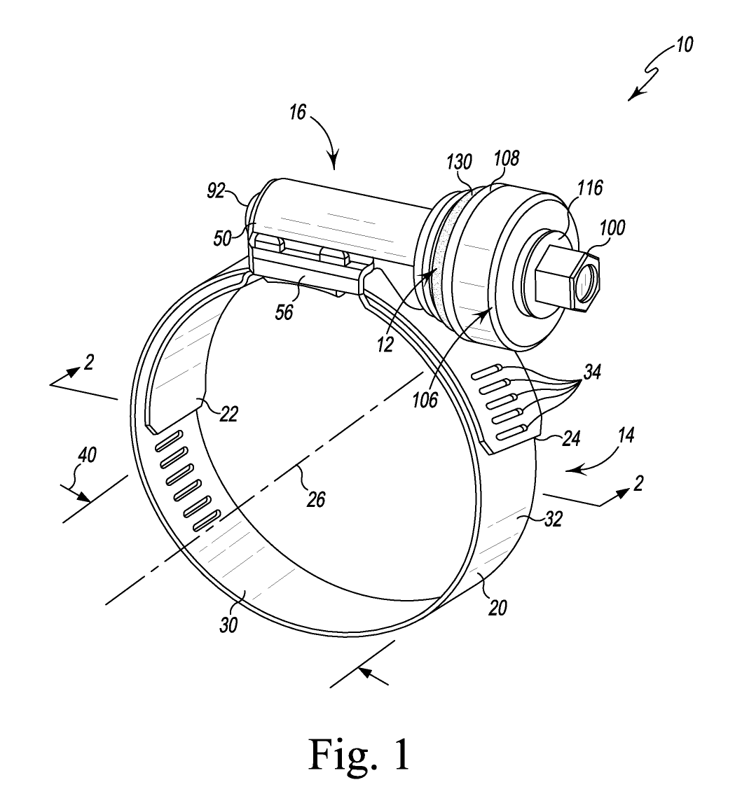

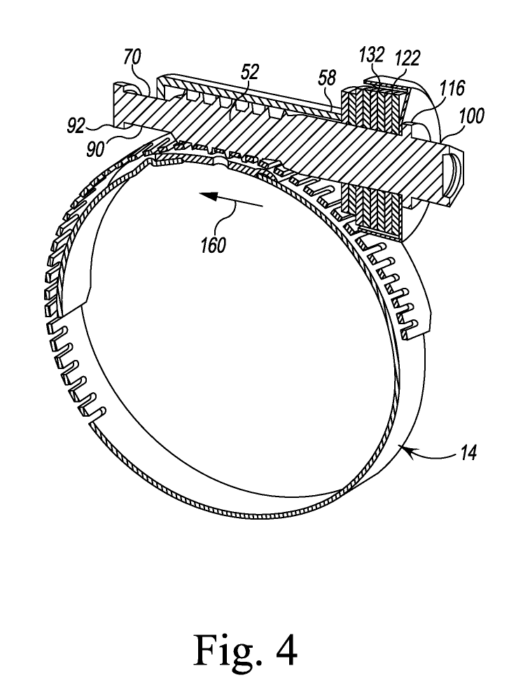

Referring now to FIG. 1, a hose clamp 10 including a visual indicator 12 is illustrated. As described in greater detail below, the visual indicator 12 is positioned so as to alert an installer or other user as to when proper band tension on a substrate 200 (see FIG. 4) has been achieved. The hose clamp 10 includes an outer band 14 and a tensioning mechanism 16 configured to apply tension to the outer band 14. The clamp 10 may also include a spring liner (not shown) that is positioned within the band 14. An exemplary spring liner is shown and described in U.S. Pat. No. 8,650,719, which is expressly incorporated herein by reference.

The outer band 14 is formed from a metallic material such as, for example, stainless steel, titanium, aluminum, or any other ferrous material. It should be appreciated that in other embodiments the outer band 14 may be formed from a non-metallic or non-ferrous material. The outer band 14 includes an elongated strip 20 that is wrapped in an annular shape such that its longitudinal ends 22, 24 overlap. As shown in FIG. 1, the outer band 14 has a central axis 26, which extends parallel to the central axis of the substrate when the hose clamp 10 is positioned on the substrate.

The elongated strip 20 includes an inner surface 30 that faces the central axis 26 and an outer surface 32 that faces away from the central axis 26. The elongated strip 20 also includes a plurality of slots 34, which extend through the surfaces 30, 32 adjacent to the longitudinal end 24 of the strip 20. In the illustrative embodiment, the slots 34 are arranged along about one-third of the total length of the elongated strip 20.

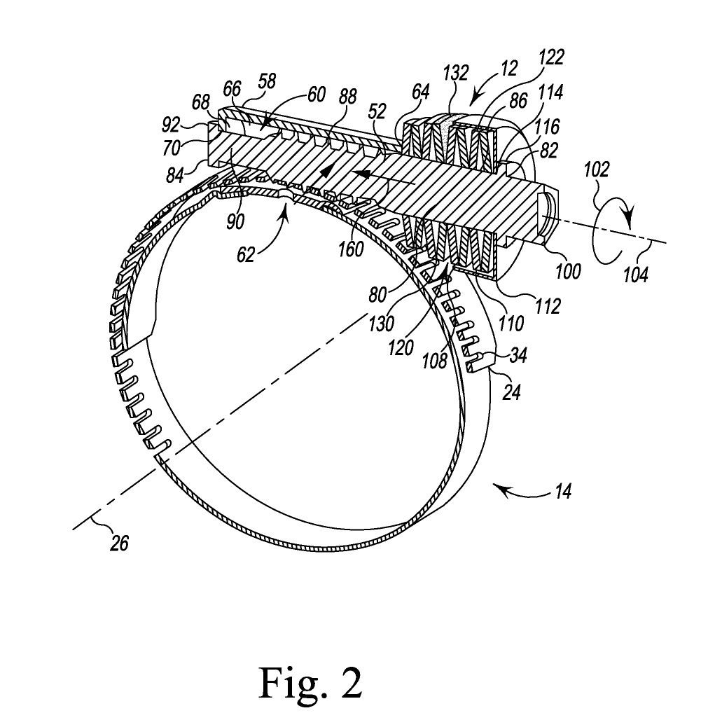

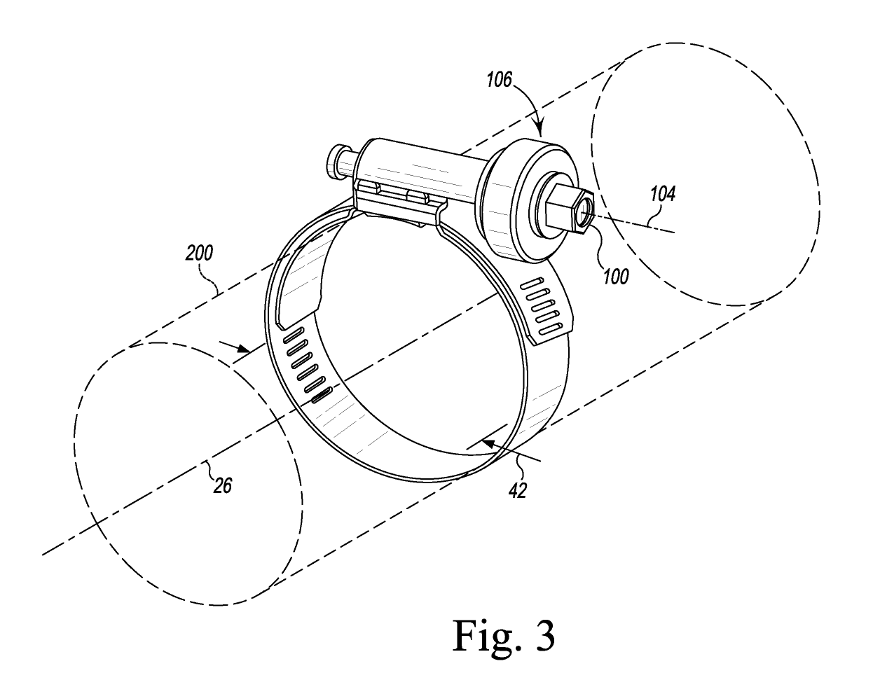

As described above, the hose clamp 10 also includes a tensioning mechanism 16 that is configured to apply tension to the outer band 14. To do so, the tensioning mechanism 16 may be operated to adjust the diameter of the outer band 14 between a plurality of diameters, including the diameter 40 shown in FIGS. 1-2 and the smaller diameter 42 shown in FIGS. 3-4. In the illustrative embodiment, the tensioning mechanism includes a housing 50 that is coupled to the outer band 14 and a threaded shaft 52 that is configured to engage the plurality of slots 34 defined in the outer band 14.

The housing 50 includes a mounting flange 56 that engages the elongated strip 20, as shown in FIG. 1. A casing 58 is attached to the flange 56. As shown in FIG. 2, the casing 58 has a central channel 60 that is sized to receive the threaded shaft 52. The central channel 60 includes an opening 62 facing the elongated strip 20 and an open longitudinal end 64. The casing 58 includes a cylindrical inner wall 66 that extends inwardly from the open longitudinal end 64 to a base wall 68 positioned at the opposite end of the casing 58. A central bore 70 extends through the center of the base wall 68.

In the illustrative embodiment, the threaded shaft 52 is an elongated body 80 that extends from a proximal end 82 to a distal end 84. As shown in FIG. 2, the elongated body 80 includes a cylindrical outer surface 86 that extends from the proximal and 82. The elongated body 80 includes a threaded section 88 that is positioned in the central channel 60 of the casing 58 and is connected to the cylindrical outer surface 86. The threads defined on the section 88 extend outwardly through the opening 62 of the casing 58 to engage the plurality of slots 34. In the illustrative embodiment, the elongated body 80 also includes a cylindrical rod 90 that extends from the threaded section 88 through the central bore 70 of the casing 58 to the distal end 84 of the body 80. An annular flange 92 extend outwardly from the end 84 to engage the casing 58 and retain the threaded shaft 52 in the casing 58.

The tensioning mechanism 16 also includes a head 100 that is secured to the proximal end 82 of the threaded shaft 52. The head 100 is hexagon and is sized to receive a corresponding socket wrench. When the head 100 is rotated in the direction indicated by arrow 102 in FIG. 2, the threaded shaft 52 is rotated about its longitudinal axis 104 to reduce the diameter of the outer band 14, as described in greater detail below.

The tensioning mechanism 16 includes a shield 106 that is mounted on the cylindrical outer surface 86 of the elongated body 80. The shield 106 has an open end 108 that faces the open end 64 of the casing 58. A cylindrical inner wall 110 extends inwardly from the open end 108 to a bottom wall 112. The bottom wall 112 includes a central bore 114, and the elongated body 80 extends through the central bore 114 to the head 100. In the illustrative embodiment, a washer 116 is positioned between the head 100 and the shield 106 to retain the shield 106 on the elongated body 80.

The tensioning mechanism 16 includes a biasing element 120 that is positioned between the casing 58 and the shield 106. In the illustrative embodiment, the biasing element 120 is a stack of springs 122, which may compress when the head 100 is rotated as indicated in FIG. 2. As shown in FIG. 2, the springs 122 are in an uncompressed state. In the illustrative embodiment, the springs 122 are Belleville washers.

Returning to FIG. 1, the hose clamp 10 includes a visual indicator 12 positioned so as to alert an installer or other user as to when proper band tension has been achieved. In the illustrative embodiment, the visual indicator 12 is incorporated into the spring stack 122. As shown in FIG. 1, the outer surface 130 of a spring (Belleville washer) 132 of the stack 122 includes a marking 134 such that the spring 132 is visually distinct from the other springs 122 in the stack. In the illustrative embodiment, the outer surface 130 is a particular color relative to the other springs in the stack. In other embodiments, the surface 130 may be etched, scored, labeled, or otherwise marked so as to be visually distinct from the other springs 122.

In use, the clamp 10 is positioned on a substrate 200 with the springs 122 in the uncompressed stated and the outer band 14 at the diameter 40. When the head 100 is rotated as indicated in FIG. 2, the threaded shaft 52 is rotated, and the engagement between the threaded shaft 52 and the slots 34 causes the end 24 of the outer band 14 to translate relative to the casing 58 and the outer band 14 to constrict in size to the diameter 42. At the diameter 42, the outer band 14 engages the substrate 200. In the illustrative embodiment, the diameter 42 matches the diameter of the substrate 200.

With the band 14 engaged with the substrate 200, further rotation of the head 100 increases the tension in the band 14. As tension increases, the bias exerted by the springs 122 is overcome, and the threaded shaft 52 shuttles relative to the casing 58 in the direction indicated by arrow 160, thereby causing the shield 106 to move toward the casing 58 and the flange 92 to move away from the casing 58, as shown in FIG. 4. In the illustrative embodiment, the springs 122 are in series with the shaft 52 and the outer band 14. Because the springs 122 are positioned between the casing 58 and the shield 106, the springs 122 compress as the shield 106 moves toward the casing 58. As the springs 122 compress, the shield 106 is advanced over the springs so that additional springs are positioned under the shield 106. When the spring 132 with the visual indicator 12 moves under the shield 106 as shown in FIGS. 3-4, the user is notified that the clamp 10 has achieved a predetermined target tension. In that way, the visual indicator 12 alerts the installer as to when the proper band tension has been achieved.

The target band tension is a function of four variables, including the uncompressed height of the spring stack; the spring rate of the spring stack; the position of the visual indicator on the spring stack; and the shield geometry and the portion of the spring stack left exposed including the visual indicator. Varying any of these variable will change the target band tension. It should be appreciated that additional embodiments may include different configurations of spring(s), visual indicators, and shield spans and orientations.

It should also be appreciated that the visual indicator may be located elsewhere on the clamp 10. For example, a marking may be added to the outer surface of the rod 90 of the threaded shaft 52. As described above, As tension increases, the bias exerted by the springs 122 is overcome, and the threaded shaft 52 shuttles relative to the casing 58 in the direction indicated by arrow 160, thereby causing the flange 92 to move away from the casing 58, as shown in FIG. 4, and exposing the rod 90. The visual indicator may be positioned on the rod 90 at a position corresponding to a predetermined target tension. As such, when the visual indicator is exposed by the movement of the threaded shaft 52, the installer is alerted that the predetermined target tension has been achieved.

The foregoing embodiments were chosen and described in order to illustrate principles of the methods and apparatuses as well as some practical applications. The preceding description enables others skilled in the art to utilize methods and apparatuses in various embodiments and with various modifications as are suited to the particular use contemplated. In accordance with the provisions of the patent statutes, the principles and modes of operation of this disclosure have been explained and illustrated in exemplary embodiments.

It is intended that the scope of the present methods and apparatuses be defined by the following claims. However, it must be understood that this disclosure may be practiced otherwise than is specifically explained and illustrated without departing from its spirit or scope. It should be understood by those skilled in the art that various alternatives to the embodiments described herein may be employed in practicing the claims without departing from the spirit and scope as defined in the following claims.

What is claimed is:

1. A hose clamp, comprising:
an annular band including a radial inner surface facing toward a central axis, the radially inner surface defining a diameter, and a radial outer surface positioned opposite the radial inner surface,
a tensioning mechanism secured to the annular band, the tensioning mechanism including a housing, a threaded shaft engaged with the radial outer surface and operable to tighten the annular band to reduce the inner diameter, a shield mounted on the shaft, and a biasing element positioned between the shield and the housing, and
a visual indicator positioned on the biasing element,
wherein the tensioning mechanism is operable to generate tension on the annular band when the hose clamp is secured to a substrate, and when a predetermined amount of tension is applied to the annular band the biasing element compresses such that the visual indicator is covered by the shield.

2. The hose clamp of claim 1, wherein the tensioning mechanism includes an elongated rod that includes the threaded shaft and a longitudinal end positioned outside of the housing, and an annular flange is positioned at the longitudinal end of the elongated rod such that the housing is positioned between the annular flange and the spring.

3. The hose clamp of claim 2, wherein the elongated rod includes a second longitudinal end, and a second annular flange is positioned at the second longitudinal end such that a section of the shield is positioned between the second annular flange and the spring.

4. The hose clamp of claim 1, wherein the visual indicator includes etching on a coil of the spring.

5. The hose clamp of claim 1, wherein the visual indicator includes a visual marking on a coil of the spring.

6. The hose clamp of claim 1, wherein the housing includes an open end sized to receive the threaded shaft, and the spring engages a rim wall of the housing that surrounds the open end.
